(19) United States
(12) Patent Application Publication
(10) Pub. No.: US 2007/0165698 A1
(43) Pub. Date: Jul. 19, 2007

(54) Pre-whitened DC free line coding

(75) Inventors: Jamal Haque, Tampa, FL (US); Timothy J. Kikta, Tarpon Springs, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/331,920

(22) Filed: Jan. 13, 2006

(51) Int. Cl. H04B 1/00

(52) U.S. Cl. 375/141

(57) ABSTRACT

A pre-whitened DC free line coding system is provided. The pre-whitened DC free line coding system comprises a scrambler adapted to whiten an input signal and an encoder adapted to convert the whitened input signal to a DC balanced signal.

### BACKGROUND

Typical DC free line encoding schemes, such as 8b/10b, 5b/6b, and 3b/4b, are used to guarantee that a given data signal has a certain number of transitions per baud rate (line signaling rate). This is important for many signaling systems, such as fiber optic and media using transformers, which need a certain number of transitions per baud rate for optimal performance. A high number of transitions helps to prevent transformer saturation and assists in clock acquisition. In addition, for data communication systems employing a clock encoded into data stream, the receiver relies on transitions embedded into the data stream to acquire the data-sampling clock. The number of transitions per baud rate drives a data recovery algorithm at the receiving end of the signaling system. The data recovery algorithm is, therefore, highly dependent on the number of transitions. However, this dependency causes possible slips in the data recovery algorithm.

Typical DC free line encoding schemes output a signal whose power spectrum is dependent on the spectral shape of the input data signal. As the input data sequence could contain extended sequences of zeros or ones, this opens a potential for energy concentrated in an area or frequency that the data recovery algorithm may not be looking at for clock acquisition. For example, typical data recovery algorithms operate in a limited bandwidth since the requirements for creating a data recovery algorithm that can operate over the whole bandwidth would stress the data recovery algorithm. However, by operating over a limited bandwidth, there is a chance that a power spectrum output, which is dependent on the spectral shape of the input signal, will have transition frequencies at the edge or outside of the data recovery algorithm processing bandwidth. If this occurs, the data recovery algorithm will not see the transition and slips in the data recovery algorithm can occur, inserting error into the data signal.

For the reasons stated above, and for other reasons stated below which will become apparent to those skilled in the art upon reading and understanding the present specification, there is a need in the art for an encoding system which removes the dependency of an encoded output power spectrum on the spectral shape of the input data signal.

### SUMMARY

The above-mentioned problems and other problems are resolved by the present invention and will be understood by reading and studying the following specification.

In one embodiment, a pre-whitened DC free line coding system is provided. The pre-whitened DC free line coding system comprises a scrambler adapted to whiten an input signal and an encoder adapted to convert the whitened input signal to a DC balanced signal.

In another embodiment, a method of removing dependency of an encoded output spectrum on the spectral shape of the input data sequence is provided. The method comprises scrambling a data signal such that the power spectrum is substantially evenly spread over a known bandwidth; and encoding the scrambled data signal to output a DC balanced signal.

In another embodiment, a data scrambler is provided. The data scrambler comprises a shift register; and at least one exclusive-OR operator (XOR), an input of the at least one XOR being coupled to one or more bits of the shift register, the register size and selection of the one or more bits coupled to the at least one XOR being based on the coding scheme of an encoder coupled to the data scrambler.

In another embodiment, a pre-whitened DC free line coding system is provided. The pre-whitened DC free line coding system comprises means for whitening a data signal; and means for encoding the whitened data signal coupled to the means for whitening the data signal, wherein the means for encoding the whitened data signal encodes the whitened data signal such that the whitened data signal is DC balanced.

### DRAWINGS

FIG. 1 is a flow chart showing a method of removing dependency of an encoded output spectrum on the spectral shape of the input data sequence according to one embodiment of the present invention.

FIG. 2 is a block diagram of a DC free line coding system according to one embodiment of the present invention.

FIG. 3 is a block diagram of a scrambler according to one embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should also be understood that the exemplary methods illustrated may include additional or fewer steps or may be performed in the context of a larger processing scheme. Furthermore, the methods presented in the drawing figures or the specification are not to be construed as limiting the order in which the individual steps may be performed. The following detailed description is, therefore, not to be taken in a limiting sense.

Embodiments of the present invention remove the dependency of an encoding scheme output signal on the spectral shape of an input signal. Hence, embodiments of the present invention enable data recovery algorithms to be designed to operate over a limited bandwidth without risking missing needed transitions. Additionally, data recovery algorithms are not stressed by the requirements of designing the data recovery algorithms to operate over the whole frequency bandwidth.

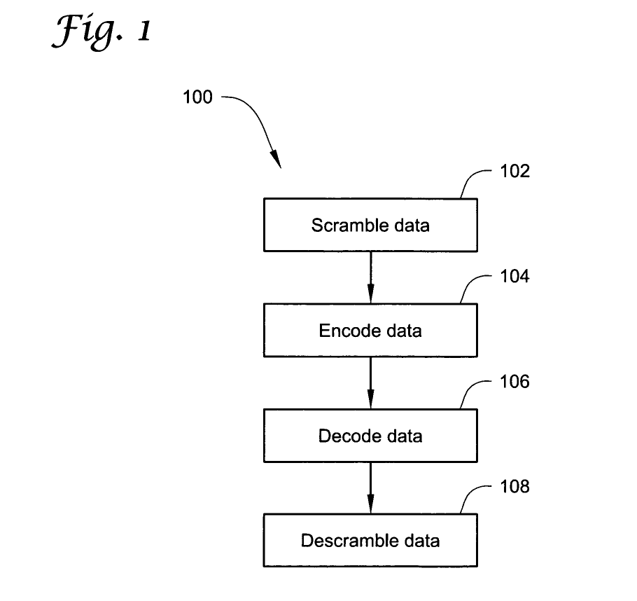

FIG. 1 is a flow chart showing a method 100 of removing dependency of an encoded output spectrum on the spectral shape of the input data sequence according to one embodiment of the present invention. At 102, a data signal is whitened (also referred to herein as scrambled). Whitening or scrambling the data signal refers to spreading the energy levels substantially evenly across a known frequency bandwidth. In some embodiments, the data signal is scrambled by generating a pseudo-random output signal and modifying the data signal based on the pseudo-random output signal. At 104, the scrambled data signal is encoded using a direct current (DC) free line encoding scheme. It will be understood by one of skill in the art that embodiments of the present invention use any appropriate DC free line encoding scheme, such as 8b/10b, 5b/6b, and 3b/4b. The encoding scheme balances DC components of the signal. If the data signal were not scrambled at 102, the encoded output spectrum would be dependent on the spectral shape of the data signal. However, since the data signal is scrambled prior to being encoded, spreading the power spectrum substantially evenly over a known bandwidth data transmission, the encoded output spectrum is not dependent on the spectral shape of the data signal.

At 106, the encoded signal is decoded by a data recovery algorithm to extract the scrambled signal. If the data signal were not scrambled, the data recovery algorithm would either risk missing necessary transitions or be stressed by the requirements of having to operate over the whole bandwidth. However, relatively little stress is placed on the recovery algorithm, in embodiments of the present invention, because the scrambled signal encoded at 104 is spread substantially evenly over a known bandwidth. Therefore, the encoded output power spectrum is substantially always spread over the same frequency bandwidth. Hence, embodiments of the present invention enable a data recovery algorithm to be designed to operate over a limited bandwidth without running the risk of missing necessary transitions due to transitions being at frequencies at the edge or outside of the processing bandwidth. At 108, the scrambled data signal is descrambled to extract the original data signal. In some embodiments, the scrambling and descrambling algorithms are synchronized by sending a synchronization bit using techniques known to one of skill in the art. In other embodiments, the scrambling and descrambling algorithms are self-synchronized based on the algorithm chosen as described in more detail below. In other embodiments, other means known to one of skill in the art are used for synchronizing the scrambling and descrambling algorithms.

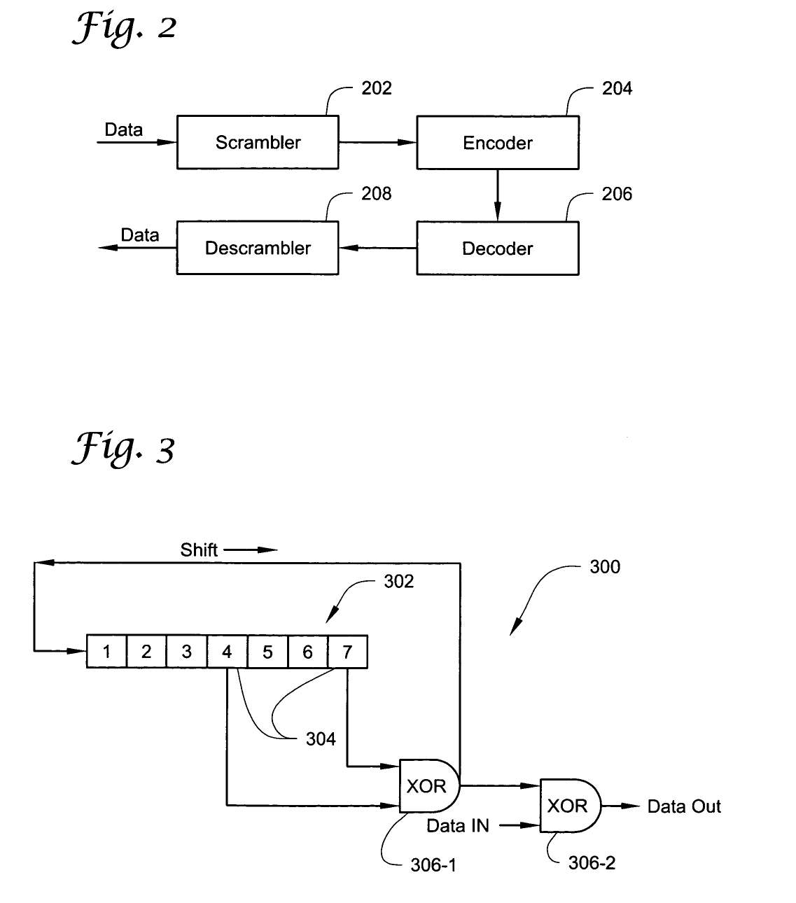

FIG. 2 is a block diagram of a DC free line coding system 200 according to one embodiment of the present invention. DC free line coding system 200 includes scrambler 202, encoder 204, decoder 206, and descrambler 208. A data signal is received by scrambler 202. Scrambler 202 scrambles or whitens the data signal such that the power spectrum of the data signal is spread substantially evenly over a known frequency bandwidth. In some embodiments, scrambler 202 is implemented as an input/output interface for receiving a digital data signal and a processor for performing a whitening algorithm on the digital data signal. In other embodiments, scrambler 202 is implemented as a linear feedback shift register having a characteristic polynomial for generating a pseudo-random number signal output. One embodiment of such a linear feedback shift register is explained in more detail below with regards to FIG. 3. In other embodiments, other means are used for whitening the data signal.

Scrambler 202 is coupled to encoder 204. Encoder 204 receives the whitened data signal and converts the whitened data signal to a DC balanced signal. In some embodiments, the encoding scheme is used one of 8b/10b, 5b/6b, and 3b/4b. In other embodiments, other DC free line encoding schemes are used. Additionally, in some embodiments, scrambler 202 and encoder 204 are incorporated in the same physical component. Decoder 208 is coupled to encoder 204 across the transmission line. Decoder 208 receives the DC balanced signal and extracts the whitened signal. As described above, the data recovery algorithm of decoder 208 is relatively less stressed since the signal encoded by encoder 204 is a whitened signal. This enables the data recovery algorithm of decoder 208 to operate over a limited bandwidth without the risk of missing necessary transitions outside that limited bandwidth.

Descrambler 208 is coupled to decoder 206. Descrambler 208 is adapted to extract the original input signal from the whitened data signal. Descrambler 208 uses the same algorithm and characteristic polynomial as scrambler 202. In some embodiments, scrambler 202 and descrambler 208 are synchronized using N frame alignment bits. The frame alignment bits are not scrambled so that a receiving terminal can extract the frame boundary. In such embodiments, shift registers are reset to a specified state of shift register at the start of each frame in both scrambler 202 and descrambler 208. In other embodiments, scrambler 202 and descrambler 208 are self-synchronized. For example, in some embodiments, an input signal is scrambled as it passes through an “excited” shift register gate. The shift register gate is excited by an external input. The scrambled signal is then automatically de-scrambled as it passes through a reversed replica of the scrambler shift register gates. By self-synchronizing the scrambler and descrambler, no framing or processing is needed to synchronize the descrambler. In other embodiments, other means are used to synchronize scrambler 202 and descrambler 208.

FIG. 3 is a block diagram of a scrambler 300 according to one embodiment of the present invention. Scrambler 300 includes shift register 302, and exclusive-OR (XOR) operators 306. Scrambler 300 operates in modula-2, in some embodiments. In varying embodiments of the present invention, shift register 302 of scrambler 300 is implemented as one of a thin film memory, individual flip-flops, a high speed core memory, and a register file. Additionally, in some embodiments one XOR is used. In other embodiments, more than one (XOR) is used. In FIG. 3, two XOR are used. In the embodiment in FIG. 3, shift register 302 is a 7-bit shift register. In other embodiments, other sizes of shift register 302 (i.e. number of bits used) are used. In FIG. 3, taps 304 (shift register outputs that influence the shift register input) are at the 4^{th} and 7^{th} bits. In other embodiments, taps 304 are at other bits. Additionally, embodiments of the present invention use M number of taps 304. In FIG. 3, two taps 304 are used. In other embodiments, other numbers of taps 304 are used. Taps 304 output the values of the bits to an XOR 306. The output of the XOR is then input into shift register 302 to change the bit values of shift register 302.

In operation, shift register 302 starts with a seed value which is the initial value of shift register 302. Taps 304 output the value of bits 4 and 7 to XOR 306-1. Based on the values of bits 4 and 7, XOR 306-1 outputs a 1 or a 0 to an input of shift register 302. This input value will shift through the bits of shift register 302 changing the value of bits 4 and 7. This cycle continues with XOR 306-1 outputting a 1 or 0 to an input of shift register 302. This process generates a pseudo-random signal sequence which eventually repeats. The pseudo-random signal is characterized by the characteristic polynomial of scrambler 300. The number of taps 304, selection of bits for taps 304, and the size of shift register 302 determine the characteristic polynomial of scrambler 300. Therefore, the length of the pseudo-random signal sequence is affected by varying the number of bits, selection of taps, and number of taps.

In FIG. 3, the characteristic polynomial is xˆ⁻⁷+xˆ⁻⁴+1 based on the 7-bit register, selection and number of taps. The characteristic polynomial is chosen based on the encoding scheme of an encoder coupled to scrambler 300. The characteristic polynomial is chosen such that the encoding scheme output of the encoder is not dependent on the pattern of pseudo-random numbers generated by scrambler 300. Additionally, the bandwidth of the data transmission line (also referred to as raw data rate) and the repeatability of the pseudo random characteristic polynomial should not be the same. The repeatability of the pseudo random characteristic polynomial should be greater than the bandwidth of the data transmission to ensure that the characteristic polynomial sequence does not put false tones within the bandwidth of interest. Hence, the number of bits, selection and number of taps in shift register 302 vary based on the encoding scheme used. The characteristic polynomial used in FIG. 3 is based on an 8b/10b encoding scheme. In other embodiments using an 8b/10b encoding scheme, other characteristic polynomials are used.

XOR 306-2, in FIG. 3, receives the output of XOR 306-1 and a data signal. XOR 306-2 modifies the data signal based on the pseudo-random signal sequence output from XOR 306-1. The data signal is, therefore, scrambled or whitened spreading the power spectrum substantially evenly over a known frequency bandwidth. This whitened signal is then received by an encoder as described above. Since the power spectrum is flat (i.e. evenly spread), encoded output of the encoder is not dependent on the spectral shape of the data signal.

The original data signal is extracted from the whitened signal by a descrambler with a similar shift-register/XOR configuration as scrambler 300. The descrambler also uses the same characteristic polynomial to descramble the whitened signal. In some embodiments, the descrambler and scrambler 300 are self-synchronized based on the seed value and characteristic polynomial chosen. In other embodiments, other means are used for synchronizing the descrambler and scrambler, such as by sending a synchronization bit.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A pre-whitened DC free line coding system comprising:
a scrambler adapted to whiten an input signal; and
an encoder adapted to convert the whitened input signal to a DC balanced signal.

2. The pre-whitened DC free line coding system of claim 1,
wherein the scrambler whitens data using a characteristic polynomial to generate pseudo-random numbers, the characteristic polynomial being chosen based on the coding scheme of the encoder.

3. The pre-whitened DC free line coding system of claim 1 further comprising:
a decoder adapted to extract the whitened signal from the DC balanced signal; and
a descrambler adapted to extract the input signal from the whitened signal.

4. The pre-whitened DC free line coding system of claim 3,
wherein the scrambler and descrambler are synchronized using a synchronization bit.

5. The pre-whitened DC free line coding system of claim 3,
wherein the scrambler and descrambler are self-synchronized based on the characteristic polynomial of the scrambler.

6. The pre-whitened DC free line coding system of claim 1,
wherein the encoder further comprises one of an 8b/10b encoder, a 5b/6b encoder, and a 3b/4b encoder.

7. The pre-whitened DC free line coding system of claim 1,
wherein the scrambler further comprises:
an input/output interface for receiving a digital data signal; and
a processor for receiving the digital data signal and performing a whitening algorithm on the digital data such that the power spectrum of the whitened digital data signal is spread substantially evenly over a known bandwidth.

8. The pre-whitened DC free line coding system of claim 1,
wherein the scrambler further comprises:
a shift register; and
at least one exclusive-OR operator (XOR), an input of the at least one XOR being coupled to one or more bits of the shift register and an output of the at least one XOR being coupled to an input of the shift register to form a pseudo-random number generator, wherein the generated pseudo-random numbers are used to whiten the data signal.

9. The pre-whitened DC free line coding system of claim 8,
further comprising:
a 7-bit shift register;
a first XOR, inputs of the first XOR being coupled to the 4^{th} and 7^{th} bits of the 7-bit shift register and an output of the first XOR being coupled to an input of the 7-bit shift register; and
a second XOR, inputs of the second XOR being coupled to an output of the first XOR and a data signal, wherein the second XOR outputs a whitened data signal based on the output of the first XOR and the data signal.

10. A method of removing dependency of an encoded output spectrum on the spectral shape of the input data sequence, the method comprising:
scrambling a data signal such that the power spectrum is substantially evenly spread over a known bandwidth; and
encoding the scrambled data signal to output a DC balanced signal.

11. The method of removing dependency of an encoded output spectrum of claim 10, wherein scrambling a data signal further comprises:
generating a pseudo-random output signal; and
modifying the data signal based on the pseudo-random output signal.

12. The method of removing dependency of an encoded output spectrum of claim 10, wherein encoding the scrambled data signal further comprises encoding the scrambled data signal using one of 8b/10b encoding, 5b/6b encoding, and 3b/4b encoding.

13. The method of removing dependency of an encoded output spectrum of claim 10, further comprising:
decoding the DC balanced signal to extract the scrambled data signal; and
descrambling the scrambled data signal to extract the data signal.

14. The method of removing dependency of an encoded output spectrum of claim 10, further comprising:
synchronizing a descrambler and a scrambler automatically based on a characteristic polynomial of the scrambler.

15. The method of removing dependency of an encoded output spectrum of claim 10, further comprising:
sending a synchronization bit to synchronize a descrambler with a scrambler to extract the correct data signal from the scrambled data signal.

16. A data scrambler comprising:
a shift register; and
at least one exclusive-OR operator (XOR), an input of the at least one XOR being coupled to one or more bits of the shift register, the register size and selection of the one or more bits coupled to the at least one XOR being based on the coding scheme of an encoder coupled to the data scrambler.

17. The data scrambler of claim 16, wherein the register size and selection of the one or more bits are based on the coding scheme of the encoder such that the output of the encoder is not dependent on the pattern of pseudo-random numbers generated by the scrambler.

18. The data scrambler of claim 17, wherein the register size and selection of the one or more bits is based on one of an 8b/10b coding scheme, a 5b/6b coding scheme, and a 3b/4b coding scheme.

19. The data scrambler of claim 16, wherein the shift register and at least one XOR further comprise:
a 7-bit shift register;
a first XOR, inputs of the first XOR being coupled to the 4^{th} and 7^{th} bits of the 7-bit shift register and an output of the first XOR being coupled to an input of the 7-bit shift register; and
a second XOR, inputs of the second XOR being coupled to an output of the first XOR and a data signal, wherein the second XOR outputs a whitened data signal based on the output of the first XOR and the data signal.

20. A pre-whitened DC free line coding system, comprising:
means for whitening a data signal; and
means for encoding the whitened data signal coupled to the means for whitening the data signal, wherein the means for encoding the whitened data signal encodes the whitened data signal such that the whitened data signal is DC balanced.

21. The pre-whitened DC free line coding system of claim 20, further comprising:
means for decoding the encoded whitened data signal coupled to the means for encoding the whitened data signal, the means for decoding being adapted to extract the whitened data signal from the encoded whitened data signal; and
means for extracting the data signal from the whitened data signal.
